(19) United States
(12) Patent Application Publication
(10) Pub. No.: US 2003/0155021 A1
(43) Pub. Date: Aug. 21, 2003

(54) Valve for the control of fluids

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,483

(22) PCT Filed: Jan. 13, 2001
(86) PCT No.: PCT/DE01/00121

(51) Int. Cl. F15B 13/044

(52) U.S. Cl. 137/625.65

(57) ABSTRACT

A valve for controlling fluids, with a valve element 4, which can be actuated by a transmission 3, in which the transmission 3 is controlled by the stroke of a piezoelectric actuator. The valve 1 according to the invention is characterized by means of the fact that the valve element 4 has a double-seat valve, in which two separate valve bodies 5, 7 are guided.

### PRIOR ART

The invention relates to a valve for controlling fluids as generically defined by the preamble to claim 1.

EP 0 477 400 A1 valve that is typical today. In a stepped bore of the valve housing, an actuating piston of the valve element is movably disposed in a small diameter part of the stepped bore. A larger piston, which can be moved by a piezoelectric actuator, is disposed in a larger diameter section of the stepped bore. A hydraulic pressure chamber filled with a pressure medium is formed between the two pistons, thus producing a hydraulic transmission of the movement of the piezoelectric actuator. Specifically, when the piezoelectric actuator moves the larger piston a certain distance, the actuating piston of the valve element executes a stroke that is extended by the transmission ratio of the piston diameter, since the piston of the piezoelectric actuator has a larger surface area than the actuating piston of the valve element. In this design, the valve element, the actuating piston of the valve element, the piezoelectric actuator, and piston that is moved by the piezoelectric actuator are are disposed one after the other along a common axis.

In addition, a hydraulically operated fuel injector with an injector housing is known from U.S. Pat. No. 5,738,071, which has a hydraulic fluid inlet and a needle control chamber. A hydraulic unit within the injector supplies pressurized fuel to the injector housing. The hydraulic unit contains an electromagnetically actuated control valve for the hydraulic fluid and can open and close the hydraulic fluid inlet. A needle valve element contains a hydraulic closing surface that is exposed to the pressure of the needle control chamber. In addition, a needle control valve is provided, which utilizes the electromagnet. The needle control valve is mounted in the injector housing and either connects the needle control chamber to a source of high-pressure fluid or shuts off the connection. In this instance, the slow response behavior of the hydraulic fluid control valve allows for a direct control of the rapidly responding needle valve by means of the fast acting electromagnet, which is the only one used.

Finally, an injector made by Bosch is known, which is equipped with a servo 3/2-seat/slider valve.

In all of these known systems, it has proven to be disadvantageous that the sliders have a very short overlap, making them unsuitable for vehicle applications with valve strokes of approximately 0.3 mm. Instead of the seat/slider valves used in these systems, known double-seat valves could in fact solve the problem of the short overlap in connection with valve strokes of approximately 0.3 mm, but the known double-seat valves cannot be used in actual practice because two seats would require two guides in an at least two-part housing due to the required balancing of force.

Advantages of the invention

The valve according to the invention, with the characteristizing features of claim 1, has the advantage over the prior art that instead of the known 3/2-seat/slider valve, a 3/2-double-seat valve can be used, in which the seats and guides do not have to extend toward each other. In addition, providing the second seat permits a hard seal to be produced compared to a slide valve with a small stroke.

In an especially advantageous embodiment, the first valve body is embodied with a pan into which the second valve body can fit. Utilizing this fairly simple design assures a tight fit between the two valve bodies.

The second valve body is advantageously embodied essentially in the form of a ball, which can fit into the pan of the first valve body in a sealed fashion.

Preferably, the ball has a cylindrical extension, which functions as a guide for the second valve body. The cylindrical elements can easily be guided at both high and low pressures and known, commercially available designs can be used.

Preferably, in its end region oriented away from the ball, the cylindrical extension is embodied with a ring.

In an especially advantageous embodiment of the valve for controlling fluids according to the invention, a tensioning element engages the ring in such a way that the ball is pressed into the pan, resulting in a tight fit. Consequently, the first and second valve bodies operate as a unit and can be disposed in a one-piece housing. In addition, the guides for the first valve body and the second valve body are separate from each other and it is not necessary for the two guides to extend toward each other.

### DRAWING

An exemplary embodiment of the invention is shown in the drawing. The exemplary embodiment will be explained in detail in the description that follows. The accompanying FIGURE schematically depicts a view of a fuel injection valve according to an exemplary embodiment of the invention.

### DESCRIPTION OF THE EXEMPLARY EMBODIMENT

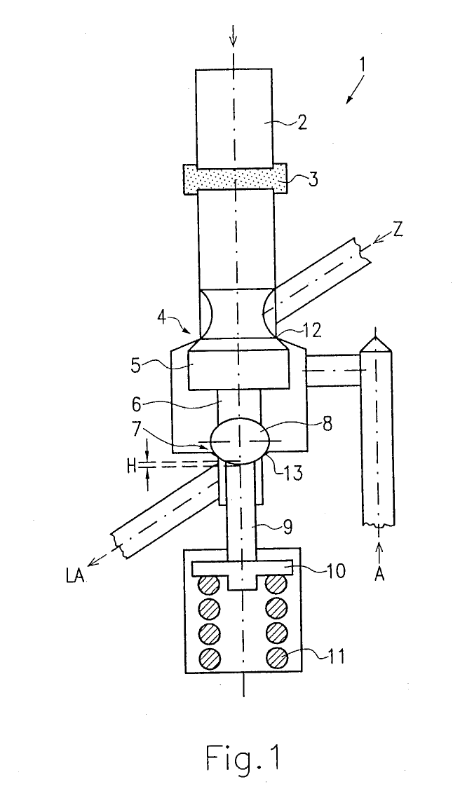

In the exemplary embodiment illustrated in FIG. 1 the valve according to the invention is used in a fuel injection system, in which the fuel injection pump and fuel injection nozzle form a unit (so-called unit injector system (UIS)). However, the known components of the fuel injection system have been omitted from FIG. 1. This allows FIG. 1 to focus solely on the novel parts of the invention.

The injection valve 1 is comprised of a decentralized pump unit, not shown, and a control unit, also not shown. In this system, the control unit contains a piezoelectric actuator, not shown, with a piston 2, which triggers a control valve 4 by means of a hydraulic transmission 3.

The control valve 4 is comprised of a first body 5, which has a so-called pan 6 at its end toward the bottom in the FIGURE. The second valve body 7 adjoins the pan 6, as shown in the FIGURE. The second valve body is comprised of a ball 8, which fits tightly into the pan 6, and a cylindrical extension 9.

In this case, the cylindrical extension 9 is guided separately from the first valve body 5 and has a ring 10 at its end toward the bottom in the FIGURE, which is embodied on the outer circumference of the cylindrical extension 9. A spring 11 engages the ring 10 and presses the ring 10, and therefore the second valve body 7 and the ball 8, against the pan 6 of the first valve body 5.

The control valve 4 is embodied with a first seat 12 and a second seat 13, which are respectively contacted by the first valve body 5 and the second valve 7 body.

Operation

The operation of the valve 1 according to the invention will be described below. If pressure is exerted on the piston 2 by a piezoelectric actuator, not shown, when it is supplied with current, then this pressure is transmitted to the first valve body 5 by means of a hydraulic transmission 3 in accordance with a predefined transmission ratio. In this instance, the first valve body is prestressed into the first seat 12 of the control valve in the neutral or currentless state of the valve 1 by the combination of spring 11 and the second valve body 7. Consequently, when the pressure transmitted by the hydraulic transmission 3 exceeds the compressive force of the spring 11, the first and second valve bodies 5, 7 are moved toward the bottom in the FIGURE until the ball 8 of the second valve body 7 comes into contact with the second valve 13. Simultaneously, fuel can flow from the inlet Z, through control valve 4, to the nozzle, not shown, via the outlet A.

If the supply of current to the piezoelectric actuator, not shown, is then switched off at this point, then the spring 11 pushes both the second and the first valve body 5, 7 toward the top in the FIGURE until the first valve body 5 engages with the first valve seat 12. On the one hand, this closes the fuel inlet Z off from the outlet A and on the other hand, it opens the overflow oil outlet LA, allowing the pressure inside the control valve 4 to be relieved by means of the overflow oil outlet LA.

It should be noted that the ball 8 of the second valve body 6 can execute a maximum stroke H when the control valve 5 is activated or when the control valve 5 is deactivated. In this instance, the stroke is on an order of magnitude of approx. 0.3 mm.

Although in the above description of an exemplary embodiment, the cooperating valve bodies 5, 7 have a pan 6 and a ball 8 to assure an adequate cooperation, it is, of course, possible for them to have matching geometric shapes other than the pan 6 and the ball 8.

Naturally, the current invention may also be used in differently configured valves with hydraulic or mechanical transmissions.

The above description of the exemplary embodiment according to the current invention is only intended for illustrative purposes and is not intended to limit the invention. In the context of this invention, various changes and modifications are possible in order to go beyond the scope of the invention and its equivalents.

1. A valve for controlling fluids with a valve element (4), which can be actuated by a transmission (3), in which the transmission (3) is controlled by the stroke of a piezoelectric actuator, characterized in that the valve element (4) has a double-seat valve, in which two separate valve bodies (5, 7) are guided.

2. A valve for controlling fluids according to claim 1, characterized in that the first valve body (5) is embodied with a pan (6), which the second valve body (7) can fit into.

3. A valve for controlling fluids according to claim 1 or 2, characterized in that the second valve body (7) is embodied essentially in the form of a ball (8).

4. A valve for controlling fluids according to claim 3, characterized in that the ball (8) has a cylindrical extension (9).

5. A valve for controlling fluids according to claim 4, characterized in that the cylindrical extension (9) is embodied with a ring (10) on its end section oriented away from the ball.

6. A valve for controlling fluids according to claim 5, characterized in that a tensioning element (11) engages the ring (10) in such a way that the ball (8) is prestressed into the pan (6) to produce a tight fit.
